(19) United States
(12) Patent Application Publication
(10) Pub. No.: US 2025/0137094 A1
(43) Pub. Date: May 1, 2025

(54) ALKALI MICROWAVE EXTRACTION

(71) Applicant: Worcester Polytechnic Institute, Worcester, MA (US)

(72) Inventors: Himanshu Tanvar, Worcester, MA (US); Brajendra Mishra, Worcester, MA (US)

(21) Appl. No.: 18/934,545

(22) Filed: Nov. 1, 2024

Related U.S. Application Data
(60) Provisional application No. 63/595,056, filed on Nov. 1, 2023.

(51) Int. Cl. C22B 34/24; C22B 3/04; C22B 3/44; C22B 4/04

(52) U.S. Cl. CPC C22B 34/24; C22B 3/04; C22B 3/44; C22B 4/04

(57) ABSTRACT

Niobium and tantalum extraction industries heavily depend on fluoride chemistry for metal oxide production. A fluoride-free approach utilizes alkali treatment for selective dissolution of niobium and tantalum phases. The application of microwave heating in the alkali treatment of columbite significantly reduced the processing time, providing a higher reaction rate and recovery than furnace or convection heating. Purified oxides are recovered using either direct precipitation or solvent extraction.

### RELATED APPLICATIONS

This patent application claims the benefit under 35 U.S.C. § 119(e) of U.S. Provisional Patent App. No. 63/595,056, filed Nov. 1, 2023, entitled “ALKALI MICROWAVE EXTRACTION,” incorporated herein by reference in entirety.

### BACKGROUND

Columbite is a mineral ore that contains two essential chemical elements, niobium and tantalum. These elements are critical raw materials for manufacturing advanced energy systems and devices, including electronics, aerospace, and medical equipment. Columbite appears as a black mineral, typically occurring as dense tabular crystals, including an oxide of iron, manganese, niobium, and tantalum. The primary application of niobium (Nb) includes its use in the steel industry to produce ferroniobium alloys, which are widely used in aerospace industries. Tantalum (Ta) metal and oxides are mainly used in capacitors, glass lenses, cutting tools, and gas turbines. Brazil is the primary producer of niobium, contributing to over 85% of the total global output, with Canada following at 10%.

### SUMMARY

An alkali heating process uses microwave energy to rapidly dissociate columbite minerals and performs the subsequent separation and recovery of Nb and Ta oxides while avoiding volatile fluoride-based approaches. Alkali heating is carried out with potassium hydroxide to form water soluble complexes of Nb and Ta. In an aqueous alkali solution, Nb and Ta are more likely to be present as hexametalate ions (HₓNb₆O₁₉^{x-8} and HₓTa₆O₁₉^{x-8}). Purified Nb and Ta oxides are recovered using either direct precipitation or solvent extraction.

Configurations herein are based, in part, on the observation that Nb and Ta are valuable materials for a variety of industrial applications, such as steel production. Unfortunately, conventional approaches to columbite refining and recovery suffer form the shortcoming that the niobium and tantalum extraction industries heavily depend on fluoride chemistry for metal oxide production. Fluoride handling imposes safeguards and handling requirements due to potential hazards. Accordingly, configurations herein substantially overcome the shortcomings of conventional fluoride based approaches by employing alkali heating using potassium hydroxide to form water soluble complexes of Nb and Ta, such that the heating process employs microwave energy to rapidly dissociate columbite minerals and performs the subsequent separation and recovery of Nb and Ta oxides with direct precipitation or solvent extraction.

Configuration herein employ an alkali heating process that uses microwave energy to rapidly dissociate columbite minerals and performs the subsequent separation and recovery of Nb and Ta oxides with solvent extraction. Alkali heating is carried out with potassium hydroxide to form water soluble complexes of Nb and Ta. In an aqueous alkali solution, Nb and Ta are more likely to be present as hexametalate ions (HₓNb₆O₁₉^{x-8} and HₓTa₆O₁₉^{x-8}). These can be extracted with a water-immiscible organic extractant that forms outer sphere assemblies or ion pairs. In view of this, quaternary ammonium salt (Aliquat® 336) was explored as an extractant for separating Nb and Ta from the alkaline solution.

In further detail, a method for recovering a mineral product from columbite as disclosed herein includes alkali heating a mineral sample including columbite, and combining the heated mineral sample with water for forming an aqueous leach slurry. Filtering the slurry yields a residue and a leached solution including the mineral product, and addition of a precipitation agent to the leached solution precipitates a solid mineral product.

### BRIEF DESCRIPTION OF THE DRAWINGS

The foregoing and other features will be apparent from the following description of particular embodiments disclosed herein, as illustrated in the accompanying drawings in which like reference characters refer to the same parts throughout the different views.

The drawings are not necessarily to scale, emphasis instead being placed upon illustrating the principles of the invention.

FIG. 1 is an X-ray diffraction (XRD) analysis of the columbite feedstock used for Nb and Ta recovery;

FIG. 2 shows variations of temperature and time using a microwave heating approach for Nb and Ta recovery from the feedstock of FIG. 1;

FIG. 3 shows dissolution of major elements resulting from the microwave heating of FIG. 2; and

FIG. 4 shows a flowchart of the recovery process of Nb and Ta including microwave heating followed by either direct precipitation or solvent extraction.

### DETAILED DESCRIPTION

Nb and Ta exist together in nature and are often associated with oxides of iron (Fe) and manganese (Mn). In the case of pegmatite and other related lithologies, tin (Sn), titanium (Ti), lithium (Li), cesium (Cs), and traces of tungsten (W), uranium (U), and thorium (Th) are also observed. The strong natural coherence of Nb and Ta is closely related to the atomic potential associated with their identical ionic radii and valence states. The columbite group minerals are the key raw material for the production of Nb and Ta. Columbite group minerals are represented by the general chemical formula AB₂O₆, where A sites represent Fe²⁺⁰ and Mn²⁺, and B sites represent Nb⁵⁺ and Ta⁵⁺. Ta, Nb, and Sn also exist in other minerals, such as pyrochlore, ixiolite, and wodginite as complex oxides and hydroxides.

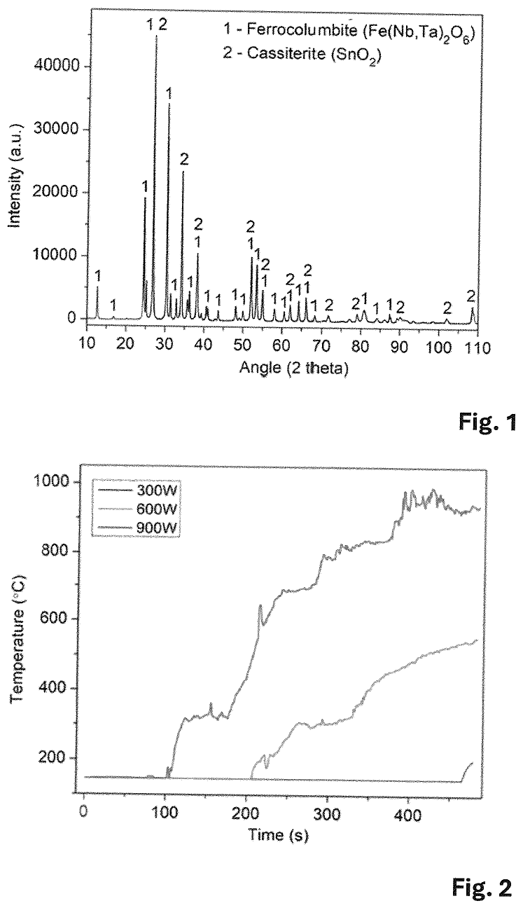

FIG. 1 is an X-ray diffraction (XRD) analysis of the columbite feedstock used for Nb and Ta recovery. Configurations disclosed below employ a columbite sample mainly composed of 21.9% Nb, 3.5% Ta, 25.9% Sn and 11.6% Fe, along with 0.9% Mn, 0.8% Si and 0.4% Al, shown in Table I. Nb and Ta values are present in the form of ferro-columbite and tantalite phases (Fe(Nb,Ta)₂O₆), whereas cassiterite (SnO₂) is the primary Sn phase. The following process can also be applied to other type of mineral and waste materials consisting of oxides of Nb and Ta after process optimization.

The thermal decomposition of columbite and tantalite with KOH results in the formation of K₃NbO₄ and K₃TaO₄ as per the chemical reaction shown in Eq. (1), below. These phases further hydrolyze in the presence of water and dissolve in the aqueous solution as per Eq. (2):

$$F {e ( Nb , Ta )}_{2} {O}_{6} + 6 KOH \to 2 {K}_{3} ( Nb , Ta ) {O}_{4} + FeO + 3 {H}_{2} O \qquad ( 1 )$$

$$6 {K}_{3} ( Nb , Ta ) {O}_{4} + ( 5 + n ) {H}_{2} O \to {{K}_{8} ( Nb , Ta )}_{6} {O}_{19} \cdot {nH}_{2} O + 10 KOH \qquad ( 2 )$$

Alkali treatment may be carried out using a high-temperature microwave furnace operated at around 2.45 GHz frequency. The preferred power level may be adjusted to the desired value through a variable power adjustment knob, and may seek other ranges. The temperature during microwave exposure was recorded using an IR thermometer focused on the top surface of the sample. The microwave treatment was carried out at variable power (300-900 W), time (3-8 min.) and KOH dosage (50-150 wt. %) to understand the effect of different variables and obtain optimized parameters. The microwave-treated sample was further ground to less than 250 microns and leached with distilled water. The leach slurry is further filtered to obtain a residue and liquid solution consisting of dissolved Nb and Ta.

TABLE I

| Element | Nb | Ta | Sn | Fe | Mn | Si | Al |
|---|---|---|---|---|---|---|---|
| Wt % | 21.90 | 3.51 | 25.96 | 11.58 | 0.88 | 0.85 | 0.36 |

The columbite concentrate (feed sample) employed for configurations herein is mainly composed of 21.9% Nb, 3.5% Ta, 25.9% Sn and 11.6% Fe, along with 0.9% Mn, 0.8% Si and 0.4% Al. Nb and Ta values are present in the form of ferro-columbite and tantalite phases (Fe(Nb,Ta)₂O₆), whereas cassiterite (SnO₂) is the primary Sn phase. The disclosed process can also be applied to other type of mineral and waste materials consisting of oxides of Nb and Ta after process optimization. FIG. 2 shows variations of temperature and time using a microwave heating approach for Nb and Ta recovery from the feedstock of FIG. 1.

Referring to FIGS. 1 and 2, FIG. 2 shows the temperature variation at different microwave exposure times of columbite and KOH (1:1) mixture at various microwave powers. At 600 and 900 W microwave power, the initial heating rate of up to 250-360° C./min was attained. A maximum temperature of 950° C. was observed at a microwave power of 900 W after 6.6 min. The rapid heating rate and high temperatures achieved within a short duration of exposure reflect the potential for application for alkali heat treatment of columbite concentrate using microwave energy. The microwave-treated material was subjected to water leaching to dissolve the water-soluble phases.

The optimized condition for alkali treatment was determined as 680 W microwave power for 5.6 min using 85 wt. % KOH. Table II shows the dissolution of different elements and the final residue composition from two experimental trials. The maximum temperature of 860° C.-900° C. was attained during these experiments and resulted in the average dissolution of 93.57% Nb, 88.12% Ta, 11.17% Sn, and 21.09% Fe. The chemical analysis of residue at optimized conditions shows that the residue is mainly concentrated with Sn (38.21%) and Fe (14.80%). Similar results can be obtained by heating the mixture of columbite concentrate and KOH in a traditional heating furnace based on electric heating, however, will require longer heating durations (1-2 h) at a temperature of 700-800° C.

TABLE II

| | | | Element | | | |
|---|---|---|---|---|---|---|
| Max. temperature | | | Nb | Ta | Sn | Fe |
| Trial 1 | 865.1° C. | Dissolution (%) | 94.00 | 88.38 | 11.85 | 24.69 |
| | | Residue | 2.24 | 0.70 | 39.05 | 14.88 |
| | | composition (%) | | | | |
| Trial 2 | 890.7° C. | Dissolution (%) | 93.15 | 87.86 | 10.49 | 17.49 |
| | | Residue | 2.35 | 0.67 | 36.37 | 14.95 |
| | | composition (%) | | | | |

Microwave heating offers several advantages over conventional heating, including selective volumetric and rapid heating of minerals, which considerably reduces the processing time and cost. Furthermore, it is important to mention that the optimized conditioned mentioned herein are specific for the sample size, composition and operating conditions specific to the sample and microwave furnace used. These conditions can be variable depending on the composition of feed material, microwave operating frequency and permissible size of sample treated. The alkali treatment can also be performed using a conventional heating furnace operated at 700-800° C. for 1-2 hours.

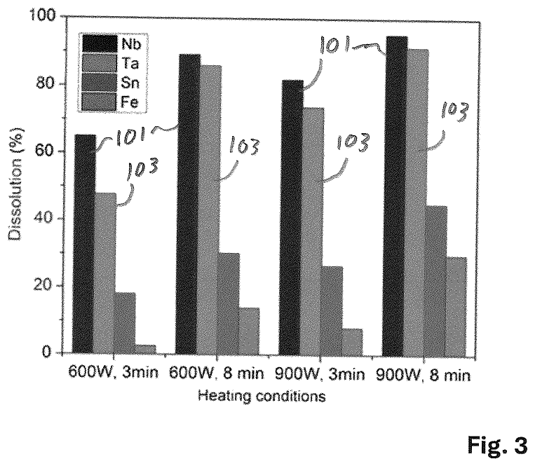

FIG. 3 shows dissolution of major elements resulting from the microwave heating of FIG. 2; Nb 101 and Ta 103 define a majority portion. The microwave-absorbing capacity of a material is often determined by its penetration depth. The penetration depth of a material is the distance over which the power of the electromagnetic wave is reduced by half and is inversely proportional to the frequency of the microwave radiation. The penetration depth is inversely proportional to microwave frequency, which can increase the permissible batch size with a decrease in the operating frequency. The penetration depth for columbite was calculated to be 5.6 cm, which is high enough for microwaves to penetrate the sample. The difficulties associated with the scale-up of microwave treatment may involve determining optimal load size and economic electromagnetic frequency range. The electrical to electromagnetic energy conversion efficiency is inversely proportional to microwave frequency, and, generally, industrial microwave furnaces operate at 915 MHz, as compared with 2.45 GHz in small-scale microwaves. Lower operating frequency will increase the penetration depth of the sample and is expected to improve the heating characteristics.

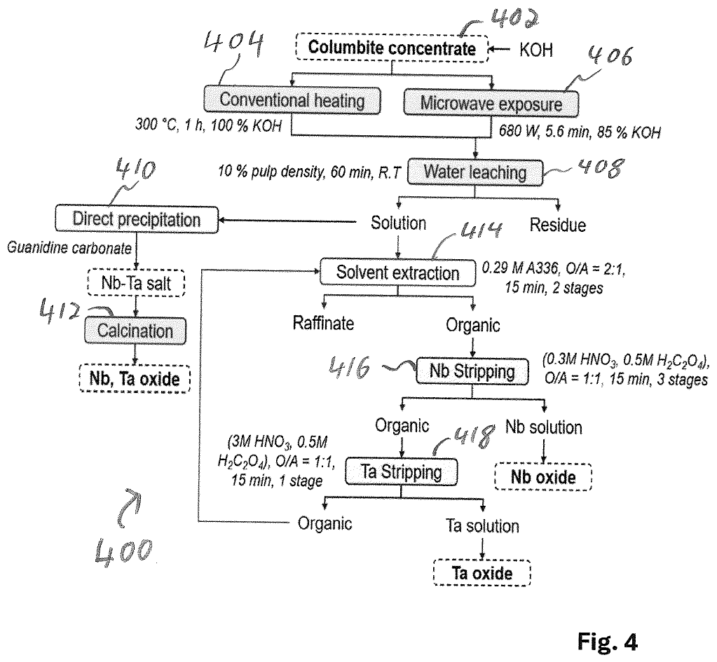

FIG. 4 shows a flowchart 400 of the recovery process of Nb and Ta including microwave heating followed by either direct precipitation or solvent extraction. Referring to FIGS. 1-4, the disclosed approach for recovering a mineral product from columbite includes alkali heating a mineral sample 402 including columbite. In contrast to conventional furnace heating, at step 404, microwave heating 406 includes microwave heating of a combination of the mineral sample and an alkali such as potassium hydroxide (KOH). Other suitable alkali substances may also be employed.

Microwave heating is typically performed at a power level between 300 and 900 watts for less than 10 minutes, typically between 5.6 and 6.6 minutes. Microwave heating results in a heat rate increase of at least 300° C./min. initially, and following an initial heating, moderates the rate increase to between 250°-300° C./min, achieving a high temperature of between 700° C.-900° C., and typically between 860° C.-890° C. The proportion of alkali is preferably in the range of 50-150 wt. % of the mineral sample. Grinding the microwave treated sample may be further performed to achieve particle sizes less than 250 microns, to facilitate Nb and Ta extraction.

The heated mineral sample is combined with water for forming an aqueous leach slurry, as depicted at step 408. The slurry is then filtered to yield a residue and a leached solution including the mineral product, resulting in a leach and residue as in table II above. The leach liquor from microwave-treated samples at optimized conditions containing approx. 19.33 g/L niobium and 3.32 g/L tantalum along with impurities of 1.62 g/L iron and 2.69 g/L tin was used for configurations herein.

The recovery of dissolved species is achieved through either of two methods: direct precipitation of mixed niobium tantalum product and separation using solvent extraction. Direct precipitation includes adding a precipitation agent to the leached solution for precipitating a solid mineral product, as depicted in step 410. The direct precipitation was carried out using guanidine amine salt as the precipitating agent to directly precipitate tantalum as a metal amine complex from an aqueous alkali solution, which was further calcined to generate pure tantalum oxide, as disclosed at step 412. Other carbonate salts may be employed. Guanidine dissolves as [H2NC(NH2)2]⁺ in an aqueous solution and interacts electrostatically with highly deprotonated hexatantalate/niobate ions ([Ta/Nb6O19]⁸⁻) and results in the formation of an insoluble salt. A stoichiometric amount of guanidine carbonate salt was added to the leach liquor, resulting in the spontaneous formation of a white precipitate of niobium and tantalum. The precipitation process was completed within 15 min with more than 99% recovery of dissolved niobium and tantalum. The resulting precipitate was washed with distilled water and calcined at 800° C. for 15 min to produce mixed niobium and tantalum oxide. Table III shows the chemical analysis of the recovered mixed oxide product using guanidine amine salt. The direct precipitation is relatively simple, generates a concentrated mixed oxide feed of more than 90% purity, and is suitable for downstream separation using traditional processes. The disclosed approach focuses on niobium and tantalum where the solid mineral product includes Nb and Ta oxides.

TABLE III

| Oxide (wt %) | Nb₂O₅ | Ta₂O₅ | SnO₂ | Fe₂O₃ |
|---|---|---|---|---|
| Mixed product from direct | 78.93 | 10.22 | 3.00 | 7.84 |
| precipitation | | | | |
| Nb product from solvent extraction | 96.28 | 2.26 | 0.03 | 1.42 |
| Ta product from solvent extraction | 43.78 | 54.70 | 1.52 | 0.00 |

The direct precipitation method at step 410 is effective in the selective extraction of niobium and tantalum; however, it is challenged by limited separation ability to produce pure oxides. Therefore, a solvent extraction route may be attempted to obtain individual metal oxide products, as shown at step 414. Methyltrioctylammonium chloride, in its hydroxide form, is utilized as an organic extractant. The extractant is equilibrated with an equimolar amount of KOH solution to replace Cl⁻ with OH⁻ before extraction was attempted. The dissolved niobium and tantalum species were simultaneously loaded into the organic phase using 0.29 M extractant at an O/A phase ratio of 2:1 in a two-stage counter-current extraction process. The extraction process resulted in 96.2% niobium and 93.4% tantalum extraction, resulting in a loaded organic phase with 9.49 g/L niobium and 1.62 g/L tantalum. Niobium and tantalum were separated during stripping using nitric and oxalic acid. In the presence of oxalic acid, niobium, and tantalum form [NbO(C₂O₄)₃]³⁻and [TaO(C₂O₄)₃]³⁻, respectively. The back extraction of niobium was performed in a 0.3 M nitric and 0.5 M oxalic acid mixture, resulting in stripping of more than 55.4% niobium in one stage. In contrast, tantalum stripping was limited to less than 5%. High tantalum extraction (>25%) was obtained using a 1-3 M nitric and 0.5 M oxalic acid mixture. Complete niobium back extraction was achieved at a low acidity level at an O/A phase ratio of 1:1 in three stages, as depicted at step 416. Subsequently, tantalum was recovered at a higher acidity level in a single stage, at step 418 The dissolved niobium and tantalum species in the stripped solution were recovered after neutralization to precipitate respective compounds, followed by calcination at 800° C. for 15 min to produce individual niobium and tantalum oxide products.

Conventional approaches to columbium processing include U.S. Pat. No. 3,712,939 (Method for recovering tantalum and/or columbium). In this approach, ground ore containing niobium and tantalum was dissolved in a hydrofluoric acid solution in a digestion tank. The solution obtained after digestion is fed to a multistage liquid-liquid extraction technique using methyl-isobutyl ketone as the extractant media. Tantalum and niobium are further recovered from the extractant media after scrubbing and back extraction.

U.S. Pat. No. 4,302,243 (Process for producing tantalum concentrates): Shows a tantalum concentrate containing rutile crystals heated with sulfuric acid of more than 90% by weight concentration at a temperature from 200° C. to 350° C. for 20 h. The heated mass is dissolved in sulfuric acid of less than 50% by weight concentration to dissolve titanium component while recovering tantalum as insoluble product, thereby producing a tantalum concentrate.

U.S. Pat. No. 3,107,976 (Niobium-tantalum separation): Presents an approach where niobium and tantalum concentrate is obtained after digestion in sulfuric acid similar to U.S. Pat. No. 4,302,243A. The hydroxide concentrate is digested in a 20 vol. % hydrofluoric acid solution. The filtered solution containing dissolved niobium and tantalum is neutralized with ammonium hydroxide to obtain mixed niobium tantalum oxide with 98% purity.

U.S. Pat. No. 2,829,947 (Method for the separation of niobium and tantalum): Proposes that ores containing niobium and tantalum pentoxides are reduced using carbon monoxide and hydrogen gas at 1000° C. The reduction process reduces a major part of niobium pentoxide to dioxide while a major part of tantalum remains in unreacted pentoxide state. The reduced material is dissolved in concentrated sulfuric acid at about 200° C. to selectively dissolve niobium dioxide and obtain tantalum pentoxide as insoluble residue.

U.S. Pat. No. 2,859,098 (Process for the separation of columbium, tantalum, and titanium values): Discloses a solution containing dissolved niobium and tantalum in fluoride complexes contacted with hydrous oxide of titanium while maintaining pH between 2-7. Tantalum and niobium are displaced by titanium and precipitated as hydrous oxide. Specific dosage of hydrous titanium oxide is required based on displacement reaction stoichiometry to selectively recover tantalum and niobium in two stages.

U.S. Pat. No. 5,209,910 (Process for the recovery and separation of tantalum and niobium): Tantalum and niobium are extracted from hydrofluoric acid solution without addition of a second mineral acid. The solvent extraction is performed using methyl-isobutyl-ketone. The loaded organic phase is first washed with sulfuric acid of 4-8 molar concentration and then with water. The washing acid (sulfuric acid) was separately removed for subsequent purification and a completely sulfate-free tantalum/niobium ketone was obtained in this way. A sulfate free aqueous niobium fluoride solution is obtained by selectively stripping niobium with water and subsequently precipitated using ammonium by known methods.

The conventional processes discussed above for extraction of niobium and tantalum oxides generally utilize hydrofluoric acid in high concentration for the dissolution of respective fluoride complexes. The dissolved solution is subsequently processed through a solvent extraction process using methyl-isobutyl-ketone as an organic extractant. There are severe environmental and health hazards associated with current industrial practices due to the use of high concentrations of fluoride ions, long reaction times and aggressive processing conditions.

In contrast, the disclosed approach proposes a fluoride-free approach for extracting niobium and tantalum oxides. Mineral concentrates of niobium and tantalum are heated with solid potassium hydroxide to form water-soluble compounds. The decomposition of columbite/tantalite phases with potassium hydroxide generates phases that are easily dissolved in water and do not require external reagent. Thermal heating of potassium hydroxide and columbite/tantalite concentrate mixture is performed using a microwave-heated furnace. The excellent microwave absorption properties of columbite and tantalum provide rapid heating characteristics, and a heating rate of up to 400° C./min can be achieved. The microwave alkali treatment process for the formation of desired phases is completed within 5 minutes, thereby reducing the processing time considerably. The application of microwaves in the alkali thermal decomposition of niobium/tantalum process makes the process quick and energy efficient. The microwave-treated mass is dissolved in water and subsequently processed through a liquid-liquid extraction process using methyltrioctylammonium chloride as an organic extractant to recover pure niobium and tantalum oxides selectively.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A method for recovering a mineral product from columbite, comprising:
alkali heating a mineral sample including columbite;
combining the heated mineral sample with water for forming an aqueous leach slurry;
filtering the slurry to yield a residue and a leached solution including the mineral product; and
adding a precipitation agent to the leached solution for precipitating a solid mineral product.

2. The method of claim 1 wherein alkali heating further comprises microwave heating of a combination of the mineral sample and an alkali.

3. The method of claim 2 wherein the alkali is potassium hydroxide.

4. The method of claim 1 wherein the precipitation agent is a carbonate salt.

5. The method of claim 2 wherein the alkali is 50-150 wt. % of the mineral sample.

6. The method of claim 1 wherein the columbite includes niobium and tantalum and the solid mineral product includes Nb and Ta oxides.

7. The method of claim 6 further comprising calcining the solid mineral product from the precipitation to yield the Nb and Ta oxides.

8. The method of claim 1 wherein the alkali heating further comprises furnace heating of the mineral sample and alkali.

9. The method of claim 8 further comprising performing the microwave heating at a power level between 300 and 900 watts.

10. The method of claim 1 further comprising heating at a rate increase of at least 300° C./min.

11. The method of claim 1 further comprising heating at a rate increase of between 250°-300° C./min.

12. The method of claim 1 further heating to a temperature between 700° C.-900° C.

13. The method of claim 2 further comprising grinding the microwave treated sample to particle sizes less than 250 microns.

14. A method for recovering a mineral product from columbite, comprising:
alkali heating a mineral sample including columbite;
combining the heated mineral sample with water for forming an aqueous leach slurry;
filtering the slurry to yield a residue and a leached solution including the mineral product; and
extracting Nb and Ta oxides from the leached solution through solvent extraction.

15. The method of claim 14 wherein solvent extraction further comprises:
combining an ammonium salt for co-extracting the Nb and Ta; and
combining the extracted Nb and Ta with a stripping solution for separating the Nb and Ta oxides.
